(19) United States
(12) Patent Application Publication
(10) Pub. No.: US 2012/0292978 A1
(43) Pub. Date: Nov. 22, 2012

(54) AXLE MODULE

(75) Inventors: Thomas Buschjohann, Nordstemmen (DE); Andreas Kiesel, Thalheim (DE); Udo Albinus, Oberhermsgruen (DE)

(73) Assignee: KSM CASTINGS GMBH, Hildesheim (DE)

(21) Appl. No.: 13/522,394

(22) PCT Filed: Jan. 20, 2011
(86) PCT No.: PCT/DE11/00057

§ 371 Date: Jul. 16, 2012

(30) Foreign Application Priority Data
Feb. 7, 2010 (DE) 10 2010 007 032.7
Sep. 26, 2010 (DE) 10 2010 046 364.7
Sep. 27, 2010 (DE) 10 2010 046 541.0

(51) Int. Cl. B60G 7/00; B60T 1/02; B60T 17/04; B29C 70/88; B29C 45/00; B29C 47/00; B60K 7/00; B29C 39/02

(52) U.S. Cl. 301/6.5; 280/124.116; 301/6.1; 264/299; 264/319; 264/328.1; 264/211.11

(57) ABSTRACT

The invention relates to an axle module for a motor vehicle, the axle module being composed of two control arms which can be fixed to the body structure via a pivotal bearing, support the wheels of the axle and are connected to each other by an axle body. According to the invention, each control arm comprises a receiving element for a drive, particularly an electric motor, particularly a wheel hub motor. The receiving device is designed such that it forms the carrier for the stator.

The invention relates to an axle module for a motor vehicle.

Such an axle module is known, for example, from DE 103 59 130 A1.

Twist beam axles such as those generally disclosed in DE 195 35 521 A1, for example, currently represent the usual rear axles for front-wheel drive cars and usually consist of two control arms, particularly longitudinal control arms, which carry the wheels or are connected with them, and an axle body, particularly a transverse profile, which connects the two control arms.

The invention is based on the task of further developing an axle module in such a manner that the axle module demonstrates improved driving dynamics properties and improved comfort and acoustics properties. The invention is furthermore based on the task of making an axle module of the type mentioned initially less sensitive to corrosion, easier to process, as well as more cost-advantageous and easier to manufacture. Furthermore, an axle module of the type mentioned initially is supposed to be developed further in such a manner that the weight is reduced, while simultaneously achieving greater ability to withstand stress. Furthermore, a more compact overall construction of the axle module is supposed to be obtained. Also, an axle module that can be driven in advantageous manner is supposed to be made available.

According to the invention, this task is accomplished with an axle module for a motor vehicle that consists of two control arms, which can particularly be attached to the vehicle body by way of a pivot bearing, carry the wheels of the axle, and are connected with one another by way of an axle body, whereby each of the control arms has an accommodation provision for a drive.

Such an axle module can be driven in advantageous manner and improves the driving dynamics properties as well as the comfort and acoustics properties of the motor vehicle. The control arm can advantageously be configured in one piece or in multiple pieces with the accommodation provision. It can be advantageous if at least a part of the wheel support is firmly connected with the control arm, firmly accommodated in the control arm, particularly integrated into it, and/or formed by the control arm. Preferably the wheel support is rigidly configured with the control arm, particularly in one piece with the control arm. The control arm can advantageously be configured in one piece or in multiple pieces with the accommodation provision. It can be advantageous if at least part of the accommodation provision is connected with the control arm, accommodated in the control arm, particularly integrated into it, and/or formed by the control arm. Preferably, at least part of the accommodation provision is configured in one piece with the control arm. As a result, the control arm and the axle module are particularly stable, and can be produced in simple and cost-advantageous manner. In total, the weight can be reduced, while simultaneously providing greater ability of the axle module to withstand stress, if at least part of the axle module, preferably the control arm and/or the accommodation provision, is produced at least in part from a light construction material. For specific application cases, a light metal can be advantageous as a light construction material. For other application cases, a plastic can be advantageous as a light construction material. For yet again other application cases, a composite of light metal and plastic can be advantageous. In this way, a more compact overall construction of a drivable axle module can be obtained.

The light metal can consist of aluminum, magnesium, zinc, or of alloys having one or more of these metals. For specific purposes of use, one or more parts of the axle module can advantageously also consist of steel or iron, particularly of cast steel or cast iron. For specific purposes of use, a sheet-metal construction can be advantageous for one or more parts of the axle module.

It can be advantageous if the plastic is a polyamide, particularly a fiberglass-reinforced polyamide. However, a plastic made of polypropylene, particularly a fiberglass-reinforced polypropylene, can also be advantageously used. For specific purposes of use, it can be advantageous if a plastic is used that is known under the name Ultramid® A3WG10 CR.

The accommodation provision itself is preferably configured in one or in multiple parts. A multi-part accommodation provision has the advantage that first, part of the accommodation provision can be connected with the control arm, subsequently the drive is inserted into this part of the accommodation provision, and the accommodation provision can finally be closed off by means of one or more further parts. The wheel support itself can also be configured in one or more parts.

It can be advantageous if the accommodation provision comprises at least a part of a housing and/or if at least a part of the accommodation provision is configured as a housing for the drive. It can be advantageous if at least a part of the housing is configured in pipe shape, for specific cases of use. For specific cases of use, it can be advantageous if at least a part of the housing is configured in pail shape. For other cases of use, it can be advantageous if at least part of the housing is configured in pot shape, and for yet other cases of use, it can be advantageous if at least a part of the housing is configured in bell shape.

The control arms, which are connected with one another by way of an axle body, can advantageously be connected with the axle body at least in part by means of gluing, by means of welding, particularly by means of resistance dot welding, by means of knurling of predetermined regions of the axle body, by means of clinching, or particularly clinching, by means of punch-riveting and/or by means of a screw connection. Axle body and control arm can advantageously form a hybrid light component composed of plastic and light metal. It can be advantageous if the control arms consist of plastic and the axle body consists of light metal, or vice versa. The control arms can advantageously be connected with the axle body by way of an injection-molding process. It is practical if the control arms and/or the axle body are configured in such a manner that the connection preferably takes place during the injection-molding process, by means of shape fit.

It can be advantageous if the axle body is produced, at least in part, from a light material, preferably from light metal, from plastic, or from a composite of light metal and plastic.

It can be advantageous if at least a part of the accommodation provision is preferably connected with the control arm in non-releasable manner. It can be practical if at least a part of the accommodation provision, at least in part, is connected with the control arm, accommodated in the control arm, particularly integrated into it, and/or formed by the control arm.

It can be advantageous if an opening of the part of the accommodation provision, which opening faces the wheel, which part is connected with the control arm, accommodated in the control arm, particularly integrated into it, and/or formed by the control arm, can be closed off with a cover, particularly in the form of a round lid.

A particular advantage can consist in that the accommodation provision, the control arm and/or the cover has/have one or more reinforcement elements, particularly reinforcement ribs, belts, beads, bulges, crosspieces and/or perforations, but preferably multiple reinforcement ribs.

It can be advantageous if the reinforcement elements run in star shape radially on the outside of the accommodation provision and/or the cover.

The drive can advantageously be a drive motor. In particular, it can be advantageous if the drive is an electric motor.

It can be particularly advantageous if the drive is a wheel hub motor.

The wheel hub motor has the advantage that the traditional drive train with transmission, differential, and drive shafts can be eliminated, and an increase in efficiency is achieved by means of the elimination of the various translations and thereby of the friction losses.

Preferably, the wheel hub motor can simultaneously be configured as a wheel hub generator, whereby an electrical control that stands in an active connection with the wheel hub motor or generator can be provided, with which control the wheel hub motor or generator can be switched between motor operation, in which a drive force is exerted on the corresponding wheel, and generator operation, in which electrical energy is generated with the rotating wheel.

It can be advantageous if at least a part of the accommodation provision or a part of the accommodation provision connected with the control arm, accommodated in the control arm, particularly integrated into it, and/or formed by the control arm is configured as a stator support.

In particular, it can be advantageous if at least a part of the accommodation provision is configured in one piece with the control arm.

It can be practical if at least a part of the accommodation provision or a part of the accommodation provision connected with the control arm, accommodated in the control arm, particularly integrated into it, and/or formed by the control arm forms the housing for the drive that is configured as an electric motor having an inner rotor, whereby the housing is firmly connected with the stator, carries and/or forms it, and the rotor rotates within the stator, as an inner rotor.

It can be practical if at least a part of the accommodation provision or a part of the accommodation provision connected with the control arm, accommodated in the control arm, particularly integrated into it, and/or formed by the control arm has a support, particularly a plate-shaped support, for the stator of the drive configured as an electric motor having an outer rotor. It can be advantageous if the support, particularly the plate-shaped support, is firmly connected with the stator, and if the rotor, which can particularly be configured in bell shape, rotates outside the stator as an outer rotor.

It can be particularly advantageous if a brake arrangement is disposed adjacent to the accommodation provision. Preferably, the brake arrangement can be integrated within the housing of the drive formed by the accommodation provision.

This is practical not only if the drive is an electric motor having an inner rotor, but also if the drive is an electric motor having an outer rotor.

It can be particularly advantageous if a main brake is disposed adjacent to the accommodation provision. Preferably, this brake can be disposed on the housing of the drive formed by the accommodation provision, or on its cover.

This can be particularly practical if the drive is an electric motor having an inner rotor.

For reasons of construction space, such a main brake can be configured as a drum brake. This main brake can be a mechanical brake that can advantageously be eliminated if electric brakes are permitted. Then a parking brake integrated into the accommodation provision, particularly in the form of a drum brake, can meet the requirements.

Furthermore, it can be advantageous if the cover has one or more bores, channels, or recesses that form brake lines and/or cooling lines, or through which brake lines and/or cooling lines are passed.

However, it can also be advantageous if the control arms, the accommodation provisions, and/or wheel supports have one or more bores, channels, or recesses that form brake lines and/or cooling lines, or through which brake lines and/or cooling lines are passed.

It can be particularly advantageous if the axes of rotation of wheel and drive coincide, in other words are disposed coaxially.

For some applications, it can be advantageous if the axle body is disposed at the level of the axes of rotation. For other applications, it can be advantageous if the axle body is disposed between the axes of rotation and the linkage for attachment of the control arms to the vehicle body. For yet other applications, it can be advantageous if the axle body is disposed at the level of the linkage for attachment of the control arm to the vehicle body.

Furthermore, it can be advantageous if at least a part of the accommodation provision is produced using a casting method. It can be particularly advantageous if the control arm is produced as a one-piece cast component with at least a part of the accommodation provision. Furthermore, it can be advantageous if at least a part of the wheel support is produced using a casting method. In particular, it can be advantageous if the control arm is produced as a one-piece cast component with at least a part of the wheel support.

It is advantageous if the control arm furthermore has a shock absorber accommodation produced by means of a casting method, particularly one connected in one piece with the arm, for attachment of a shock absorber between control arm and the vehicle body.

It can be advantageous if the control arm furthermore has a spring support surface or accommodation connected in one piece with it, preferably produced by means of a casting method, for accommodation of a corresponding spring, particularly a helical spring.

However, these individual accommodations disposed on the control arms of the axle module can also be attached to the control arms by means of screwing, welding, material removal, or the like, for specific purposes of use.

It can be particularly practical if at least a part of the accommodation provision or a cast component of the axle module is produced by means of squeeze-casting, counter-pressure ingot mold casting (CPC), die-casting, particularly by means of thixocasting, rheocasting, and low-pressure sand casting, or by means of gravity ingot mold casting. It can also be advantageous if at least a part of the accommodation provision or a cast component of the axle module is produced using the injection-molding process.

It is advantageous if the invention relates to axle modules whose control arm, in each instance, is rigidly connected with the wheel support. In this connection, it is practical if the wheel support is connected, particularly in one piece, with the control arm, particularly longitudinal control arm, accommodated in it, particularly integrated into it, and/or formed by it. It is advantageous if at least a part of the wheel support is connected in one piece with the control arm, particularly longitudinal control arm, accommodated in it, particularly integrated into it, and/or formed by it.

It can be particularly advantageous and practical if the axle module is configured as a composite control arm axle.

The term composite control arm axle is very broad. For specific purposes of use, this can advantageously be what is called a torsion crank axle or torsion control arm axle. For other purposes of use, it can advantageously be what is called a coupling control arm axle. For yet again other purposes of use, it can be a composite control arm axle in the narrower sense. One speaks of a torsion crank axle if the transverse connection, particularly the axle body, lies very close to the wheel center and thus has properties similar to a rigid axle. One speaks of a composite control arm axle in the narrower sense if the transverse connection, particularly the axle body, lies close to the longitudinal control arm mounting and thus has properties similar to a longitudinal control arm axle. One speaks of a coupling control arm axle if the transverse connection, particularly the axle body, is situated approximately on the front third of the longitudinal control arms, and thereby combines advantages of the longitudinal control arm axle with the composite control arm axles in the narrower sense.

It can be advantageous if the composite control arm axle comprises an axle body or transverse support oriented in the transverse vehicle direction, configured to be resistant to bending and soft to torsion, and two control arms, particularly longitudinal control arms, oriented in the longitudinal vehicle direction and configured to be resistant to bending and to torsion. It can be advantageous if their furthermost front ends, seen in the longitudinal vehicle direction, are firmly connected with the axle body or transverse support, and if the accommodation provision for accommodating the drive, provided according to the invention, is disposed at their back ends, in each instance, whereby the drive stands in an active connection with the wheel mounted on the accommodation provision.

For specific applications, it can be particularly advantageous and practical if the axle module is configured as a longitudinal control arm axle or as a central control arm axle, as it is currently being used in the BMW Mini, for example.

For specific applications, it can be particularly advantageous and practical if the axle module is configured as a rigid axle.

For some applications, it can be particularly advantageous and practical if the axle module is configured as a slanted control arm axle or as a screw control arm axle.

It can be advantageous if the axle module is configured as a driven rear axle of a two-axle or multi-axle motor vehicle. In this way, an all-wheel drive can be implemented in particularly simple manner, whereby the front axle can be driven using an internal combustion engine, for example.

The control arms can be produced using the casting method, preferably together with at least a part of the accommodation provision. For specific purposes of use, it can also be practical if the control arms are produced from one or more injection-molded, extruded, continuously cast or cast profiles. For specific application cases, it can be advantageous if at least a part of the accommodation provision is produced from at least one injection-molded, extruded, continuously cast or cast profile.

The axle body can advantageously be configured as a T, V, or U profile, or as a tubular profile having a preferably pressed-in cross-section in C shape. The latter shape ensures improved conditions in the connection region to the control arms or to the longitudinal control arms, respectively. The axle body can advantageously be produced from an injection-molded, extruded, continuously cast or cast profile.

The accommodation provision can advantageously be disposed at one end of the control arm. An accommodation, preferably in the form of a bushing, can be disposed at the other end of the control arm, for attachment means for attachment of the axle module on the vehicle body.

It can be advantageous if the control arm has an accommodation for attachment of the axle body.

The axle module according to the invention can advantageously be used in an electric vehicle or a hybrid vehicle. A vehicle having a conventional front-axle drive and a rear-axle drive according to the invention is preferred as a hybrid vehicle.

Further details and advantageous embodiments of the invention are evident from the following description in combination with the drawing. This shows:

FIG. 1 a perspective view of an axle module according to the invention of a motor vehicle (for an electric motor having an inner rotor),

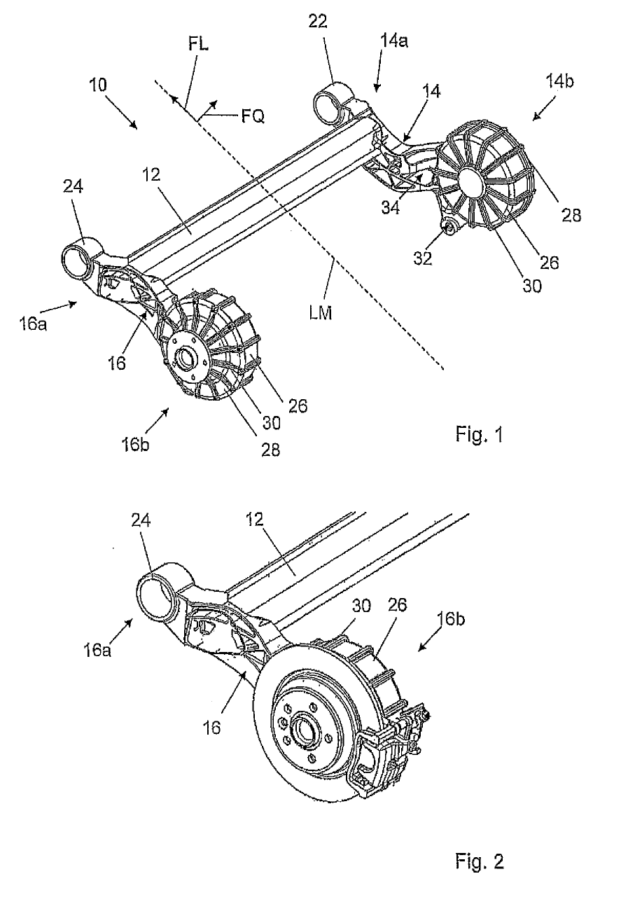

FIG. 2 a detail of a perspective view of an axle module according to the invention of a motor vehicle (for an electric motor having an inner rotor),

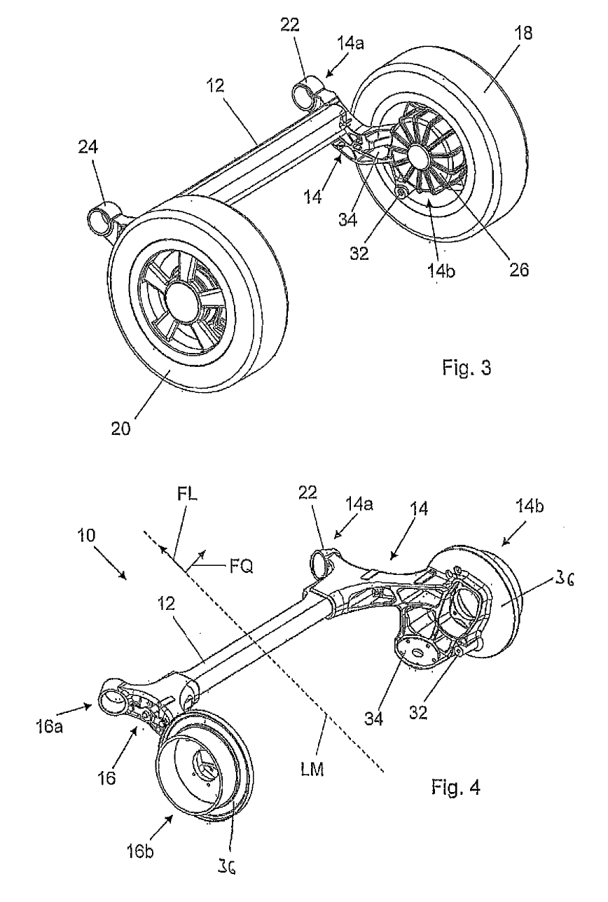

FIG. 3 a perspective view of an axle module according to the invention plus wheels (for an electric motor having an inner rotor),

FIG. 4 a perspective view of an axle module according to the invention of a motor vehicle (for an electric motor having an outer rotor),

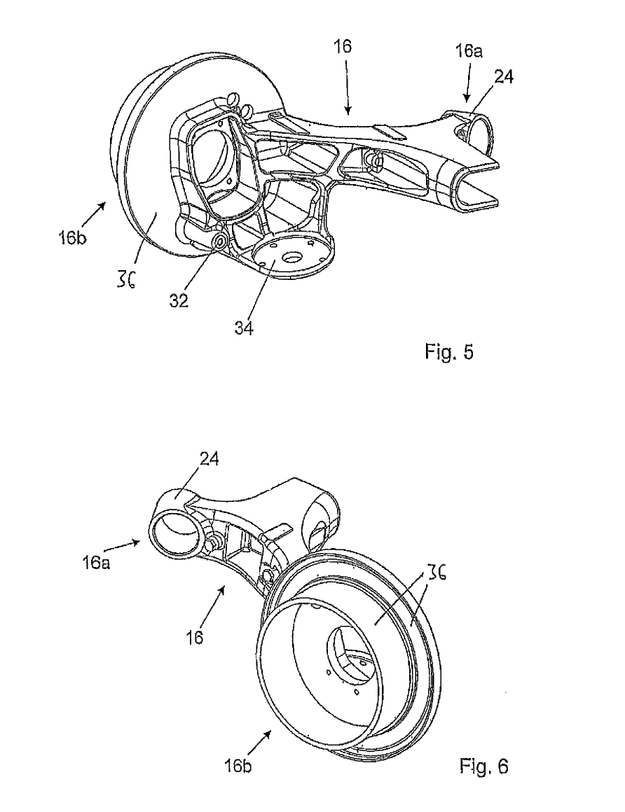

FIG. 5 a detail of a perspective view of an axle module according to the invention of a motor vehicle (for an electric motor having an outer rotor),

FIG. 6 a detail of a perspective view of an axle module according to the invention of a motor vehicle (for an electric motor having an outer rotor),

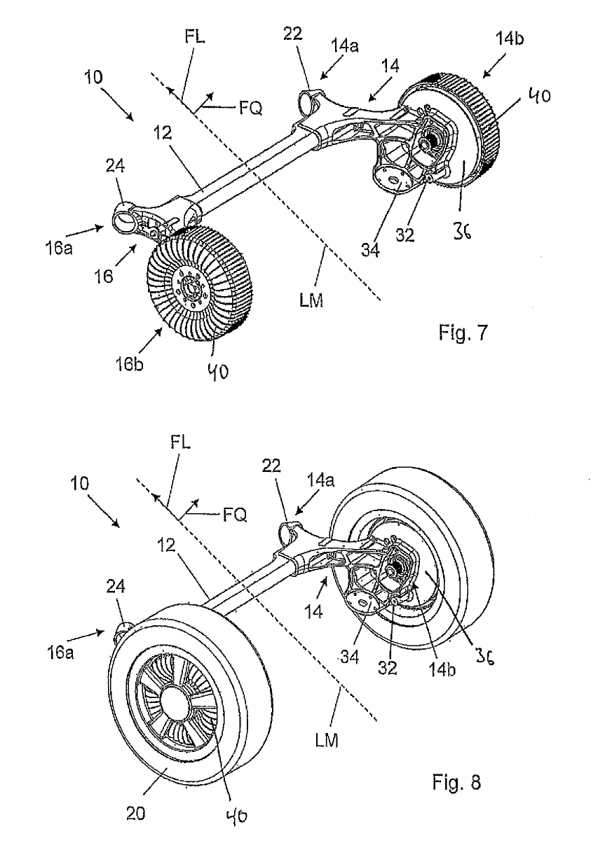

FIG. 7 a perspective view of an axle module according to the invention of a motor vehicle (for an electric motor having an outer rotor),

FIG. 8 a perspective view of an axle module according to the invention plus wheels (for an electric motor having an outer rotor),

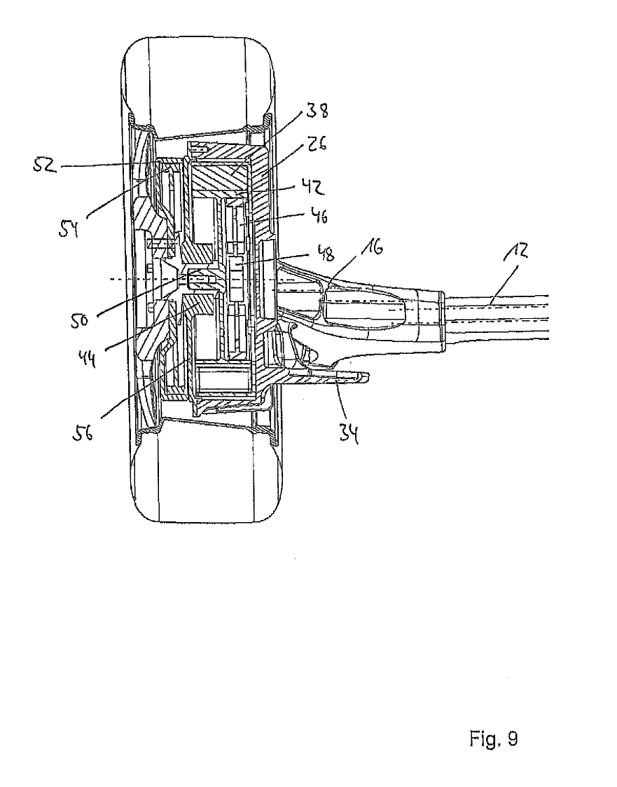

FIG. 9 a sectional view of a wheel-carrying region of an axle module having an electric motor having an inner rotor, as well as a main brake lying on the outside and a parking brake lying on the inside,

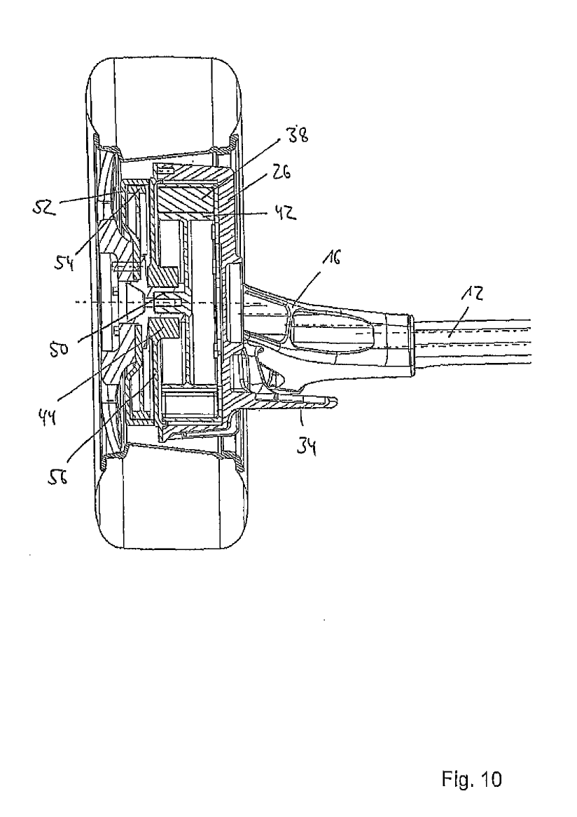

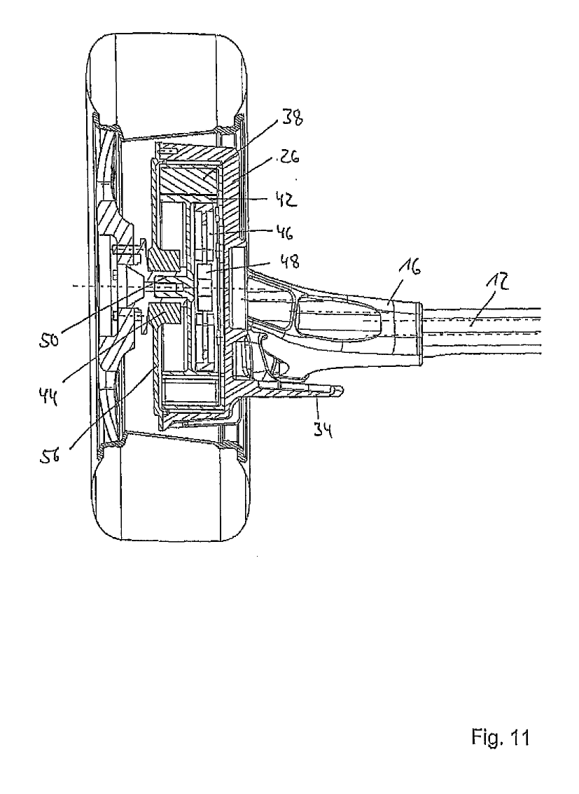

FIG. 10 a sectional view of a wheel-carrying region of an axle module having an electric motor having an inner rotor, as well as a main brake lying on the outside,

FIG. 11 a sectional view of a wheel-carrying region of an axle module having an electric motor having an inner rotor, as well as a parking brake lying on the inside,

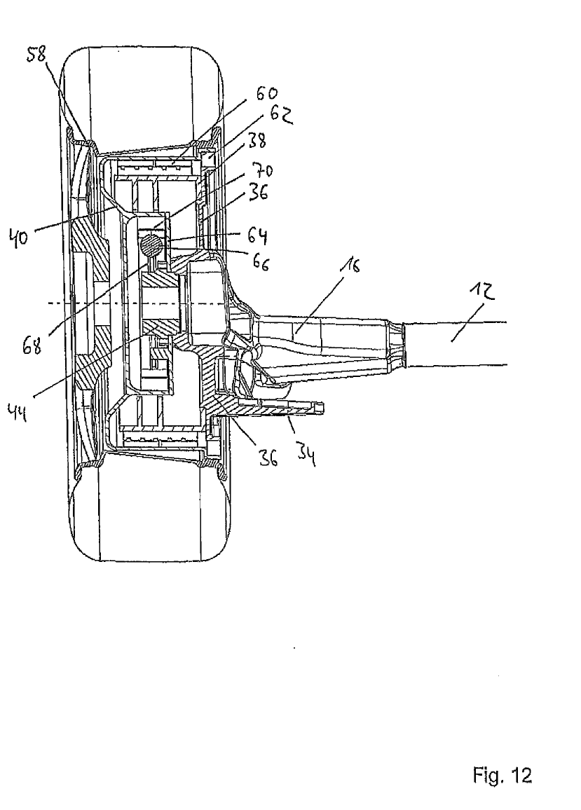

FIG. 12 a sectional view of a wheel-carrying region of an axle module having an electric motor having an outer rotor, as well as a parking brake lying on the inside.

In order to avoid repetitions, the same reference symbols are used in the figures, if they relate to the same components.

The longitudinal direction of travel of the motor vehicle is indicated with an arrow FL, and the transverse vehicle direction is indicated with an arrow FQ.

The twist beam axle 10 essentially comprises an axle body 12 or transverse body oriented in the transverse vehicle direction FQ, as well as a first and a second longitudinal control arm 14, 16 oriented in the longitudinal vehicle direction FL, in each instance. The axle body 12 is configured to be resistant to bending and soft to torsion, while the first longitudinal control arm 14 and the second longitudinal control arm 16 are configured to be resistant to bending and to torsion, for example.

The first and second longitudinal control arm 14, 16 each have a front end 14a, 16a and a back end 14b, 16b, respectively. The front ends 14a, 16a of the longitudinal control arms 14, 16 are firmly connected with the axle body 12.

At the back ends 14b, 16b of the longitudinal control arms 14, 16, an accommodation provision for an electric motor, particularly a wheel hub motor, is provided, according to the invention. In this connection, the accommodation provision is configured in such a manner that it forms the support 26, 36 for the stator 38.

The invention differentiates, in the exemplary embodiments shown, between two variants of an axle module 10 having an accommodation provision according to the invention. The accommodation provision is configured either for an electric motor having an outer rotor 40 or for an electric motor having an inner rotor 42.

In FIGS. 1 to 3 as well as FIGS. 9 to 11, axle modules or details of them having an accommodation provision for an electric motor having an inner rotor 42 are shown, while in FIGS. 4 to 8 as well as 12, axle modules or details of them for an electric motor having an outer rotor 40 are shown.

In FIGS. 1 to 3 as well as FIGS. 9 to 11, an accommodation provision in the form of a pot-shaped housing part 26 for accommodation of a wheel hub motor is disposed in each longitudinal control arm 16, whereby the wheel hub motor stands in an active connection with the wheel 18, 20 to be driven, in each instance. The pot-shaped housing part 26 can be closed off by means of a cover 28. The pot-shaped and covering housing parts 26, 28 have multiple reinforcement ribs 30 that increase the rigidity of the control arm, which ribs run in star shape on the outside, in each instance. The housing parts 26, 28 are preferably screwed to one another.

In this connection, the wheel hub motor is configured as an electric motor having an inner rotor, whereby the housing part 26 of the housing forms the housing of the electric motor, which is firmly connected with or carries the stator 38, which has windings, whereby the rotor 40 of the electric motor, which has permanent magnets, rotates within the stator 38 as an inner rotor.

Further components of the wheel hub motor having an inner rotor and of their arrangement, particularly of their brake arrangements, can be seen very well in FIGS. 9 to 11. In this connection, the following reference numbers refer to the following components:
44 wheel bearing
46 brake shoe with brake lining (integrated parking brake)
48 brake cam (integrated parking brake)
50 spline for transfer of torque
52 brake drum (main brake)
54 brake shoe with brake lining (main brake)
56 brake support=cover 28 (main brake)

In FIGS. 4 to 8 as well as FIG. 12, an accommodation provision in the form of a plate-shaped housing part 36 is disposed in each longitudinal control arm 16, as a support for the stator of the wheel hub motor, whereby the wheel hub motor stands in an active connection with the wheel 18, 20 to be driven, in each instance. In this connection, the wheel hub motor is configured as an electric motor having an outer rotor 40, whereby the housing part 36 carries what is called the stator of the electric motor, whereby what is called the rotor 40 rotates outside of the stator 36.

Further components of the wheel hub motor having an outer rotor and of their arrangement according to the invention, particularly of the brake arrangement, can be seen very well in FIG. 12. In this connection, the following reference numbers refer to the following components:
58 rim
60 permanent magnet
62 seal
64 support sheet metal for drum (parking brake)
66 brake cylinder (parking brake)
68 brake shoe (parking brake)
70 brake lining

Each of the wheels 18, 20 of the twist beam axle 10 is driven by an individual wheel hub electric motor. Preferably, each of the two individually driven wheels 18, 20 can be controlled separately, in this connection, thereby making it possible to transfer different drive forces and to implement an electronic stability program as well as driving dynamics regulations.

The twist beam axle 10 is attached to the body of the motor vehicle, not shown here, with the bushings 22, 24 disposed at the front ends 14a, 16a of the longitudinal control arms 14, 16, still in front of the connection region of the axle body 12, which bushings are preferably connected in one piece with the longitudinal control arms 14, 16.

Each longitudinal control arm 14, 16 has a shock absorber accommodation 32 connected with it in one piece, in each instance, for attachment of a shock absorber between the longitudinal control arm 14, 16 and the motor vehicle body. Each longitudinal control arm 14, 16 furthermore has a spring accommodation 34 connected with it in one piece, in each instance, for accommodation of a corresponding spring, particularly a helical spring.

The invention is not restricted to the exemplary embodiment, but rather can be varied in many different ways, within the scope of the disclosure. All the new individual characteristics and combinations of characteristics disclosed in the specification and/or in the drawing can be essential to the invention.

1: Axle module for a motor vehicle, consisting of two control arms, which can be attached to the vehicle body, carry the wheels of the axle, and are connected with one another by way of an axle body, wherein each of the control arms has an accommodation provision for a drive.

2: Axle module, particularly according to claim 1, wherein the control arm is configured in one part or multiple parts with the accommodation provision.

3: Axle module, particularly according to claim 1, wherein the control arm is configured in one part or multiple parts with the wheel support.

4: Axle module, particularly according to claim 1, wherein this module is produced at least in part from a light material.

5: Axle module, particularly according to claim 4, wherein the light material is a light metal, a plastic, or a composite of light metal and plastic.

6: Axle module, particularly according to claim 5, wherein the light metal consists of aluminum, magnesium, zinc, or alloys having one or more of these metals.

7: Axle module, particularly according to claim 6, wherein the plastic is a polyamide, particularly a fiberglass-reinforced polyamide.

8: Axle module, particularly according to claim 1, wherein the accommodation provision is configured in one part or multiple parts.

9: Axle module, particularly according to claim 1, wherein the wheel support is configured in one part or multiple parts.

10: Axle module, particularly according to claim 1, wherein the accommodation provision comprises at least a part of a housing and/or wherein at least a part of the accommodation provision is configured as a housing for the drive.

11: Axle module, particularly according to claim 10, wherein at least a part of the housing is configured in the shape of a pipe, pail, pot, or bell.

12: Axle module, particularly according to claim 1, wherein at least a part of the accommodation provision, at least in part, is connected with the control arm, accommodated in the control arm, particularly integrated into it, and/or formed by the control arm.

13: Axle module, particularly according to claim 1, wherein an opening of the part of the accommodation provision, which opening faces the wheel, which part is connected with the control arm, accommodated in the control arm, particularly integrated into it, and/or formed by the control arm, can be closed off with a cover.

14: Axle module, particularly according to claim 1, wherein the accommodation provision and/or the cover and/or the control arm has/have one or more reinforcement elements, particularly reinforcement ribs, belts, beads, bulges, crosspieces and/or perforations, but preferably multiple reinforcement ribs.

15: Axle module, particularly according to claim 14, wherein the reinforcement elements run in star shape radially on the outside of the accommodation provision and/or the cover.

16: Axle module, particularly according to claim 1, wherein the drive is a drive motor.

17: Axle module, particularly according to claim 1, wherein the drive is an electric motor.

18: Axle module, particularly according to claim 1, wherein the drive is a wheel hub motor.

19: Axle module, particularly according to claim 1, wherein at least a part of the accommodation provision or a part of the accommodation provision connected with the control arm, accommodated in the control arm, particularly integrated into it, and/or formed by the control arm is configured as a stator support.

20: Axle module, particularly according to claim 1, wherein at least a part of the accommodation provision and/or at least a part of the wheel support is/are configured in one piece with the control arm.

21: Axle module, particularly according to claim 1, wherein at least a part of the accommodation provision forms the housing for the drive that is configured as an electric motor having an inner rotor, wherein the housing is firmly connected with the stator, carries and/or forms it, and the rotor rotates within the stator, as an inner rotor.

22: Axle module, particularly according to claim 1, wherein at least a part of the accommodation provision has a support, particularly a plate-shaped support, for the stator of the drive configured as an electric motor having an outer rotor.

23: Axle module, particularly according to claim 22, wherein the support, particularly the plate-shaped support, is firmly connected with the stator, and wherein the rotor, which is particularly configured in bell shape, rotates outside the stator as an outer rotor.

24: Axle module, particularly according to claim 1, wherein a brake arrangement is disposed adjacent to the accommodation provision.

25: Axle module, particularly according to claim 24, wherein a brake arrangement is disposed within the housing of the drive formed by the accommodation provision.

26: Axle module, particularly according to claim 1, wherein the drive is an electric motor having an inner or outer rotor.

27: Axle module, particularly according to claim 1, wherein a parking brake is disposed adjacent to the accommodation provision.

28: Axle module, particularly according to claim 27, wherein the parking brake is disposed on the housing of the drive formed by the accommodation provision.

29: Axle module, particularly according to claim 28, wherein the drive is an electric motor having an inner rotor.

30: Axle module, particularly according to claim 13, wherein the cover has one or more bores, channels, or recesses that form brake lines and/or cooling lines, or through which brake lines and/or cooling lines are passed.

31: Axle module, particularly according to claim 1, wherein the control arms, the accommodation provisions, and/or the wheel supports have one or more bores, channels, or recesses that form brake lines and/or cooling lines, or through which brake lines and/or cooling lines are passed.

32: Axle module, particularly according to claim 1, wherein the axes of rotation of wheel and drive coincide.

33: Axle module, particularly according to claim 32, wherein the axle body is disposed at the level of the axes of rotation.

34: Axle module, particularly according to claim 32, wherein the axle body is disposed between the axes of rotation and the linkage for attachment of the control arms to the vehicle body.

35: Axle module, particularly according to claim 32, wherein the axle body is disposed at the level of the linkage for attachment of the control arm to the vehicle body.

36: Axle module, particularly according to claim 1, wherein the control arm is produced as a cast component, at least with a part of the accommodation provision and/or the wheel support.

37: Axle module, particularly according to claim 1, wherein the control arm is produced as a one-piece cast component, at least with a part of the accommodation provision and/or the wheel support.

38: Axle module, particularly according to claim 1, wherein at least a part of the accommodation provision or a cast component of the axle module is produced by means of squeeze-casting, counter-pressure ingot mold casting (CPC), die-casting, particularly by means of thixocasting, rheocasting, and low-pressure sand casting, or by means of gravity ingot mold casting.

39: Axle module, particularly according to claim 1, wherein at least a part of the accommodation provision or a cast component of the axle module is produced using the injection-molding process.

40: Axle module, particularly according to claim 1, wherein the axle module is configured as the drive rear axle of a two-axle or multi-axle motor vehicle.

41: Axle module, particularly according to claim 1, wherein the control arm or the accommodation provision is produced at least in part as an injection-molded, extruded, continuously cast or cast profile.
